(19) United States
(12) Patent Application Publication
(10) Pub. No.: US 2025/0029457 A1
(43) Pub. Date: Jan. 23, 2025

(54) DIGITAL INK AUTOMATED TELLER MACHINE

(71) Applicant: Wells Fargo Bank, N.A., San Francisco, CA (US)

(72) Inventors: Debashis Ghosh, Charlotte, NC (US); Kurt D. Newman, Fortson, GA (US)

(21) Appl. No.: 18/065,454

(22) Filed: Dec. 13, 2022

(51) Int. Cl. G07F 19/00; G06Q 30/0251

(52) U.S. Cl. CPC G07F 19/206; G06Q 30/0251; G06Q 20/1085; G06Q 20/4014

(57) ABSTRACT

Techniques are described for providing financial institution-specific branding and transactions based on a transaction request initiated by a user at a digital ink ATM and subsequent receipt of a cryptogram from the user's payment card at the digital ink ATM. An ATM server device receives the cryptogram from the digital ink ATM and, based on identifying information included in the cryptogram, determines the financial institution associated with the payment card. The ATM server device then communicates with a bank server device associated with the financial institution to authenticate the user. Upon authentication, the bank server sends a file containing branding information specific to the financial institution to the ATM server. The ATM server then sends instructions to the digital ink ATM displays, including a digital ink display, to display the branding information to the user. The bank server device then authorizes performance of the transaction at the digital ink ATM.

### TECHNICAL FIELD

The disclosure relates to computer-based systems for managing transactions via automated teller machines.

### BACKGROUND

Automated teller machines (ATMs) typically owned by financial institutions provide account holders with a convenient way to perform account access functions. In some examples, the financial institution that a particular ATM belongs to is indicated by the use of branding information presented on the exterior of the ATM, such as images, colors, or logos relating to the financial institution. Users may choose whether to initiate a transaction at a particular ATM based on these visual indicators. Once a user has decided to initiate a transaction at an ATM, a user may insert a credit or debit card that contains identifying information. The identifying information may include the user's name, account number, or the like. The identifying information may be contained in a magnetic stripe of the card and/or an integrated circuit (IC) chip of the card that is read by a card reader of the ATM. The user may also enter a personal identification number (PIN) in order to further verify their identify for the transaction. Upon receiving the identifying information, a server owned by the financial institution associated with the payment card may authenticate the user and later authorize completion of the transaction at the ATM.

### SUMMARY

The disclosure describes techniques for providing branding information that is specific to a financial institution associated with a user's payment card to a generic automatic teller machine (ATM) that includes a digital ink display component upon receipt of a cryptogram read from the user's payment card at the ATM. In some examples, a user may dip, swipe, or hold their payment card proximate to an ATM card reader and a server device associated with the ATM may receive the cryptogram, including the unique identifier, read from the user's payment card. Upon receipt of the cryptogram of the payment card, the server device determines a financial institution associated with the user's payment card based on the unique identifier included in the cryptogram. In some examples, the server device may comprise a bank server device or be in communication with a bank server device associated with the financial institution. The server device retrieves branding information specific to the financial institution based on the unique identifier. The branding information may include a color scheme, logos, or other images specific to the financial institution. The server device transmits instructions to the ATM to display the branding information specific to the financial institution via the digital ink display component of the ATM.

The digital ink display component of the ATM may include one or more panels covering an exterior of the ATM where each panel may display at least a portion of the branding information specific to the financial institution. The digital ink display component may utilize electrophoretic technology to display images or text in various colors in accordance with the branding information specific to the financial institution. The digital ink display component allows the branding information presented on the exterior of the ATM to be frequently changed or updated, thus allowing the ATM to display branding information for a particular financial institution selected from multiple different financial institutions based on the unique identifier included in a cryptogram received from a payment card at the ATM. In this way, the digital ink display component of the ATM may change the branding information from a first financial institution upon conclusion of a session with the first financial institution and subsequently display branding information specific to a second financial institution upon receipt of a second cryptogram of a second payment card associated with the second financial institution at the ATM.

The techniques described herein may provide one or more benefits or advantages. The disclosed server devices and associated digital ink ATMs may allow for multiple financial institutions to provide their own branding to more ATMs at more locations. In this way, the disclosed system enables users to interact with an appropriately branded ATM during all transactions without the financial institutions having to own and maintain all of the ATMs. In addition, for digital ink ATMs that are owned by a particular financial institution or other organization, the digital ink display components require less power than commonly used liquid crystal display (LCD) screens, which may reduce the operational cost of the ATMs. Furthermore, in some scenarios, the particular financial institution or other organization that owns the digital ink ATMs may charge a service fee to other financial institutions for use of the digital ink ATMs. Additionally, digital ink display components are typically less reflective than LCD screens, which allows the displayed branding information to be more visible to users in direct sunlight.

In one example, this disclosure is directed to a system including a server device, the server device comprising a memory and one or more processors in communication with the memory. The one or more processors are configured to: receive a cryptogram of a payment card of a user from an ATM, wherein the ATM receives the cryptogram of the payment card when the payment card is read by the ATM; identify, based on a unique identifier included in the cryptogram of the payment card, a financial institution associated with the payment card; retrieve, based on the unique identifier, branding information specific to the financial institution; and transmit, to the ATM, instructions to display the branding information specific to the financial institution via a digital ink display component of the ATM.

In another example, this disclosure is directed to a method comprising: receiving, by a server device of a computing system, a cryptogram of a payment card of a user from an ATM, wherein the ATM receives the cryptogram of the payment card when the payment card is read by the ATM; identifying, by the server device and based on a unique identifier included in the cryptogram of the payment card, a financial institution associated with the payment card; retrieving, by the server device and based on the unique identifier, branding information specific to the financial institution; and transmitting, by the server device and to the ATM, instructions to display the branding information specific to the financial institution via a digital ink display component of the ATM.

In a further example, this disclosure is directed to a computer-readable medium storing instructions that, when executed, cause one or more processors to: receive a cryptogram of a payment card of a user from an ATM, wherein the ATM receives the cryptogram of the payment card when the payment card is read by the ATM; identify, based on a unique identifier included in the cryptogram of the payment card, a financial institution associated with the payment card; retrieve, based on the unique identifier, branding information specific to the financial institution; and transmit, to the ATM, instructions to display the branding information specific to the financial institution via a digital ink display component of the ATM.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example network system that includes one or more server devices configured to provide financial institution-specific branding to digital ink ATMs, in accordance with the techniques of this disclosure.

FIG. 2 is a conceptual diagram illustrating an example digital ink ATM, in accordance with the techniques of this disclosure.

FIG. 3 is a block diagram illustrating an example bank server configured to facilitate ATM transactions and send branding information to an ATM server or directly to a digital ink ATM, in accordance with the techniques of this disclosure.

FIG. 4 is a block diagram illustrating an example ATM server configured to send branding information to a digital ink ATM, in accordance with the techniques of this disclosure.

FIG. 5 is a block diagram illustrating an example digital ink ATM, in accordance with the techniques of this disclosure.

FIG. 6 is a flow chart illustrating an example operation of server devices to facilitate digital ink ATM branding, in accordance with aspects of the disclosure.

### DETAILED DESCRIPTION

The disclosure describes techniques for providing branding information specific to a financial institution associated with a payment card to an automatic teller machine (ATM) having a digital ink display component in response to receipt of a cryptogram read from the payment card at the ATM. A user may dip, swipe, or hold their payment card proximate to an ATM card reader, and upon determining the financial institution associated with the payment card based on a unique identifier included in the cryptogram read from the payment card, a server device retrieves branding information specific to the financial institution and transmit instructions to the ATM to display the branding information specific to the financial institution-specific via the digital ink component of the ATM. The branding information may include a color scheme, logos, icons, or images specific to the financial institution.

In some examples, the server device may be an ATM server device and may communicate with a bank server associated with the financial institution in response to identifying the financial institution from the unique identifier included in the cryptogram of the payment card received from the ATM. The ATM server device may retrieve the branding information from the bank server and store the branding information in a cache or other local memory for faster retrieval in response to receipt of a subsequent cryptogram of a payment card that is also associated with the financial institution. In this way, the server device may retrieve and/or store branding information for multiple different financial institutions to enable appropriate branding information to be sent to the digital ink ATM in response to receipt of cryptograms identifying any of the different financial institutions. In other examples, the server device may be a bank server associated with a particular financial institution.

The server device may also receive user credentials, e.g., a personal identification number (PIN), alpha-numeric password, and/or biometric marker or signal, for a bank account of the user from the ATM after the ATM reads the cryptogram of the user's payment card. In scenarios where the server device is a bank server, the server device may itself authenticate the user of the payment card to access the bank account via the ATM based on validating the user credentials of the user. In scenarios where the server device is an ATM server, the server device may send the user credentials to the bank server of the identified financial institution for user authentication. A similar communication flow may be used to process transactions requests received from the user via the ATM. Upon completion of one or more transactions at the ATM, the user's session may end and the ATM may stop displaying the branding information specific to the financial institution, in accordance with instructions received from the server device. In some situations, the ATM may be instructed to continue displaying the branding information specific to the financial institution via the digital ink display component until receipt of a second cryptogram read from a second payment card by the ATM card reader.

ATMs are typically owned by a single financial institution or corporation, which is often indicated by the use of images, colors, logos, icons, and/or other visual branding information. The branding information may be presented to a user via a user interface display, signage, or the exterior covering of an ATM. Due to the static nature of printed/painted signage or hard coverings though, the exterior branding information for most ATMs cannot be easily updated. However, the nature of digital ink technology, also known as e-paper or e-ink technology, allows for displays to be easily changed and/or updated. Although some ATMs may utilize liquid-crystal displays (LCDs) to display frequently changing visual information, digital ink technology has shown to be a less power intensive, less costly, and potentially more durable alternative for displaying visual information.

Digital ink technology was first marketed by E Ink Corporation and was popularized in c-readers for its ability to create electronic displays that mimic paper. Digital ink displays typically consist of a multi-layered panel that utilizes oppositely charged electrodes to display pigment in the form of an image or text. A bottom electrode, which may consist of a thin film transistor, is separated from a transparent top electrode by a transparent liquid layer, e.g., a hydrocarbon oil, that contains millions of microcapsules. Within each microcapsule exists charged white and black or dark pigment particles, often consisting of titanium dioxide, wherein the black or dark pigment particles carry a charge opposite to that of the white pigment particles. Drivers and controllers work to apply charges across the panel. Depending on the charge applied, the pigment particles will move towards or away from the transparent top electrode in a way that causes a certain image or text to be shown across the digital ink display, as the charged particles at the top of the panel will either reflect or absorb light. Additionally, some digital ink companies have created digital ink displays that can show color. For example, the E Ink Kaleido™ is a digital ink display that consists of an RGB color filter placed over the monochrome microcapsules and below a front light. The RGB color filter allows the E Ink Kaleido™ to display 4096 colors and 16 levels of greyscale.

The driver for a digital ink panel may receive images transferred via universal serial bus (USB) or other communication channels or protocols from a source such as a computing device including one or more processors or processing circuitry. For example, the driver may consist of a control unit, a circuit board, and multiple contact elements. Once the driver receives an image via a communication module, it may write or send charges to the digital ink display panel to display the image. Due to the nature of digital ink technology, power does not have to be applied continuously to maintain a static image across the display. Digital ink displays can require little to no power once the desired image is displayed, and only require power once the image needs to be changed or updated. Therefore, digital ink displays typically consume much less power than other types of displays that require constant refresh. Additionally, the nature of digital ink technology allows for digital ink displays to be highly visible in sunlight, which may serve as a benefit for ATMs, as they are frequently placed in outdoor environments.

Provided that ATMs are typically owned by a single financial institution or corporation, ATMs are typically manufactured with static branding specific to the single financial institution or static generic branding without affiliation to a particular financial institution. This may cause consumer confusion and/or lead to brand-dilution. This disclosure describes one or more server devices in communication with digital ink ATMs to provide branding information to the ATMs based on financial institutions identified from payment card cryptograms read by ATM card readers. The disclosed server devices and associated digital ink ATMs may allow for multiple financial institutions to provide their own branding to more ATMs at more locations. In this way, the disclosed system enables users to interact with an appropriately branded ATM during all transactions without the financial institutions having to own and maintain all of the ATMs. In addition, for digital ink ATMs that are owned by a particular financial institution or other organization, the digital ink display components require less power than commonly used LCD screens, which may reduce the operational cost of the ATMs. Furthermore, in some scenarios, the particular financial institution or other organization that owns the digital ink ATMs may charge a service fee to other financial institutions for use of the digital ink ATMs.

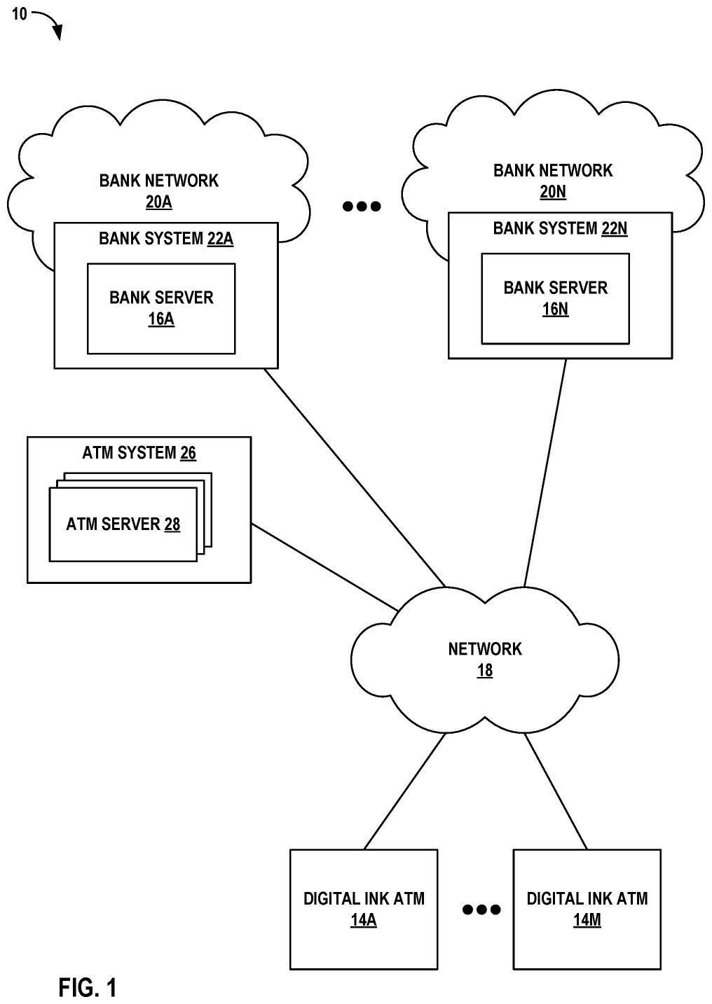

FIG. 1 is a block diagram illustrating an example network system that includes one or more server devices configured to provide financial institution-specific branding to digital ink ATMs, in accordance with the techniques of this disclosure. As shown in the example of FIG. 1, network system 10 includes bank networks 20A-20N (collectively, “bank networks 20”) for a plurality of different financial institutions, where bank networks 20 include respective bank systems 22A-22N (collectively, “bank system 22”) having bank servers 16A-16N (collectively, “bank servers 16”). Network system 10 also includes ATM system 26 that include a plurality of ATM servers 28 and a plurality of digital ink ATMs 14A-14M (collectively, “digital ink ATMs 14”).

In the example of FIG. 1, bank servers 16, ATM servers 28, and digital ink ATMs 14 are all in communication via network 18. In some examples, network 18 may be a private network or a public network, such as the Internet. Although illustrated as a single entity, network 18 may include a combination of two or more public and/or private networks. Network 18 may include one or more of a wide area network (WAN) (e.g., the Internet), a local area network (LAN), a virtual private network (VPN), or another wired or wireless communication network. In some examples, network 18 may be a service provider network coupled to one or more networks administered by other providers, and may thus form part of a large-scale public network infrastructure, e.g., the Internet.

The financial institutions affiliated with bank networks 20 may be traditional banks or credit unions with the capability to maintain user accounts, or may be a third-party for storing information for one or more traditional banks or credit unions but may not necessarily maintain any user accounts. Each of bank networks 20 may comprise a centralized or distributed system of computing devices, such as desktop computers, laptops, workstations, wireless devices, cloud-based compute nodes, network-ready appliances, file servers, print servers, or other devices, configured to execute and/or support all or a portion of bank systems 22. For example, each of bank networks 20 may include or have access to a plurality of databases, data centers, public or private cloud systems, and other storage facilities in which checking, savings, and/or investment accounts for users are stored.

As illustrated in the example of FIG. 1, bank server 16A is an example computing device used to support bank system 22A. The functionality of each of bank servers 16 may be implemented in hardware or in a combination of software and hardware, where requisite hardware may be provided to store and execute software instructions. While shown as a single computing device in each bank system in the example of FIG. 1 for purposes of illustration, in some examples, bank servers 16 may each include a distributed network of computing devices including one or more workstations, servers, and/or other computing devices within each of bank networks 20.

ATM servers 28 comprise example computing devices used to support ATM system 26. The functionality of each of ATM servers 28 may be implemented in hardware or in a combination of software and hardware, where requisite hardware may be provided to store and execute software instructions. In the example of FIG. 1, ATM system 26 includes multiple ATM servers 28, which may be generic servers or servers owned by different financial institutions that are each in communication with a particular one of bank servers 16 owned by the respective financial institution. ATM servers 28 within ATM system 26 may be distributed such that at least one of ATM servers 28 is located in a similar geographic area as at least one of digital ink ATMs 14.

Digital ink ATMs 14 may be devices used to perform a variety of account access functions, such as, for example, financial transactions including one or more of withdrawal transactions, fund deposits, fund transfers, check cashing, or account balance checks. Digital ink ATMs 14 may include a user interface display for displaying and receiving information to and from users. Digital ink ATMs 14 may each include a digital ink display component for displaying financial institution-specific branding information, in accordance with the techniques of this disclosure. The digital ink display component of each of digital ink ATMs 14 may include one or more panels configured to use electrophoretic technology to display images or text in various colors in accordance with the branding information specific to the financial institution. Additionally, digital ink ATMs 14 may each include a physical keyboard, a touch display, a scanner, one or more card readers, and/or other input devices for receiving inputs. Digital ink ATMs 14 may also each include components for vending or accepting cash and/or checks for various transactions including, for example, conventional deposits or withdrawals, exchange of local currency for foreign currency or vice versa, and/or withdrawal of foreign currency. One or more of digital ink ATMs 14 may include a printer component for printing documents for various transactions including, for example, receipts for deposits, receipts for withdrawals, receipts for purchases, or the like. One or more of digital ink ATMs 14 may include a component to dispense envelopes. Digital ink ATM 14 may also each include a component to dispense cash and/or a component to dispense cash within an envelope. The components of digital ink ATMs 14 described herein may be separate components, each dedicated to a separate function, or may be combined in any suitable number of components to perform the functions described herein. A single component may include different subcomponents used for performing different tasks or may use the same subcomponents for each task according to particular needs.

Bank systems 22 provide authenticated users with secure access to bank accounts held by the respective financial institutions. To provide access and perform transactions via an ATM, one of digital ink ATMs 14, e.g., digital ink ATM 14A, may request from the user some combination of a payment card cryptogram and user credentials, such as a static personal identification number (PIN), a one-time passcode (OTP), an access code, or biometric markers or signals, received via a user interface of ATM 14A. For example, digital ink ATM 14A may establish a communication session with a user's payment card, e.g., a physical payment card or a user device that includes a virtual payment card in a mobile wallet application running on the user device, such that the payment card and digital ink ATM 14A can exchange messages securely. For example, the payment card may transmit a cryptogram upon a user inserting (e.g., dipping or swiping) a portion of a physical payment card that includes an integrated circuit (IC) chip or a magnetic strip into a slot of a card reader of digital ink ATM 14A. As another example, the payment card may transmit a cryptogram upon a user holding a physical payment card or a user device executing a mobile wallet application in proximity to a wireless card reader of digital ink ATM 14A.

Upon receipt of the cryptogram and user credentials, digital ink ATM 14A may send at least the cryptogram to an associated one of ATM servers 28 or an associated one of bank servers 16 via network 18. For example, the one of ATM servers 28 may identify a financial institution based on a unique identifier included in the cryptogram of the payment card. In some cases, the first four digits of an account number of a payment card may indicate an associated financial institution, e.g., a bank, credit union, or other card-issuing entity. In some examples, the one of ATM servers 28 may determine one of bank servers 16, e.g., bank server 16A, associated with the identified financial institution. Digital ink ATM 14A may then communicate with bank server 16A either directly or via the one of ATM servers 28 over network 18. For example, in some scenarios, the one of ATM servers 28 may send the cryptogram and user credentials to bank server 16A via network 18.

Bank server 16A of bank system 22A of bank network 20A associated with the identified financial institution may receive the cryptogram and user credentials from either digital ink ATM 14A or the one of ATM servers 28 over network 18. Bank server 16A may authenticate the user to access the user's bank account held by the identified financial institution via digital ink ATM 14A based on validating the user credentials. After authentication, bank server 16A enables the user to access information related to their bank account to perform account access functions and/or financial transactions requested by the user via digital ink ATM 14A. For example, bank server 16A may receive transaction requests entered by the user from digital ink ATM 14A or the one of ATM servers 28. Bank server 16A may authorize completion of the requested transactions at digital ink ATM 14A. Bank network 20A may perform the requested transactions including one or more of fund deposits and withdrawal transactions. In examples where a transaction at least in part comprises a cash withdrawal, bank server 16A may withdraw an amount of funds for the cash withdrawal from the bank account of the user and send instructions for digital ink ATM 14A to dispense the amount of funds to the user via a cash dispenser at digital ink ATM 14A.

In accordance with the techniques of this disclosure, in response to determining that the payment card at digital ink ATM 14 is associated with the particular financial institution based on the unique identifier included in the cryptogram of the payment card, the one of ATM servers 28 retrieves branding information that is specific to the identified financial institution. The branding information may include color schemes, logos, icons, or images specific to the financial institution. In some examples, the one of ATM servers 28 may retrieve the branding information from a cache or other local storage based on the unique identifier of the financial institution. For example, the cache may store branding information for multiple different financial institutions indexed by their unique identifiers. In other examples, if the one of ATM servers 28 does not have a locally stored copy of the branding information or if the locally stored branding information needs to be updated, the one of ATM servers 28 may send a request for the branding information to bank server 16A associated with the identified financial institution, and, in response, receive the branding information from bank server 16A. The one of ATM servers 28 may then store the branding information specific to the identified financial institution received from bank server 16A in the cache or local storage of the one of ATM servers 28 indexed by the unique identifier of the financial institution.

Upon retrieving the branding information specific to the identified financial institution, the one of ATM servers 28 transmits, to digital ink ATM 14A, instructions to display the branding information specific to the financial institution via the digital ink display component of digital ink ATM 14A. In some examples, the instructions may include instructions for each panel of the one or more panels of the digital ink display component of digital ink ATM 14A to display at least a portion of the branding information specific to the financial institution. Moreover, the instructions may include instructions to display the branding information for a session duration of one or more transactions requested by the user of the payment card and performed at digital ink ATM 14A. In this example, once the user has completed all transactions at digital ink ATM 14A and the user session is complete, the instructions may cause digital ink ATM 14A to stop displaying the branding information specific to the financial institution and revert to a generic color scheme. In other examples, digital ink ATM 14A may continue to display the branding information specific to the financial institution after the user session is complete and until receipt of instructions to display branding information specific to a second financial institution in response to receipt of a second cryptogram from a second payment card read by digital ink ATM 14A.

In some additional examples, the digital ink display components of digital ink ATMs 14 may be leveraged in the authentication of the user. For example, in response to receipt of the cryptogram of the user's payment card from digital ink ATM 14A, the one of ATM servers 28 or bank server 16A associated with the identified financial institution associated with the user's payment card, may transmit instructions to digital ink ATM 14A to display a user-specific image via the digital ink component of the ATM. The user-specific image may be selected based on user information included in the cryptogram of the payment card. In some examples, the user-specific image may be an image that was previous selected or agreed upon by the user and stored in a user profile associated with the user's bank account within bank network 20A. The one of ATM servers 28 or bank server 16A may then receive user credentials for the bank account of the user and an indication of the user-specific image from digital ink ATM 14A. The bank server 16A may then authenticate the user of the payment card to access the bank account via digital ink ATM 14A based on validating the user credentials of the user and the indication of the user-specific image.

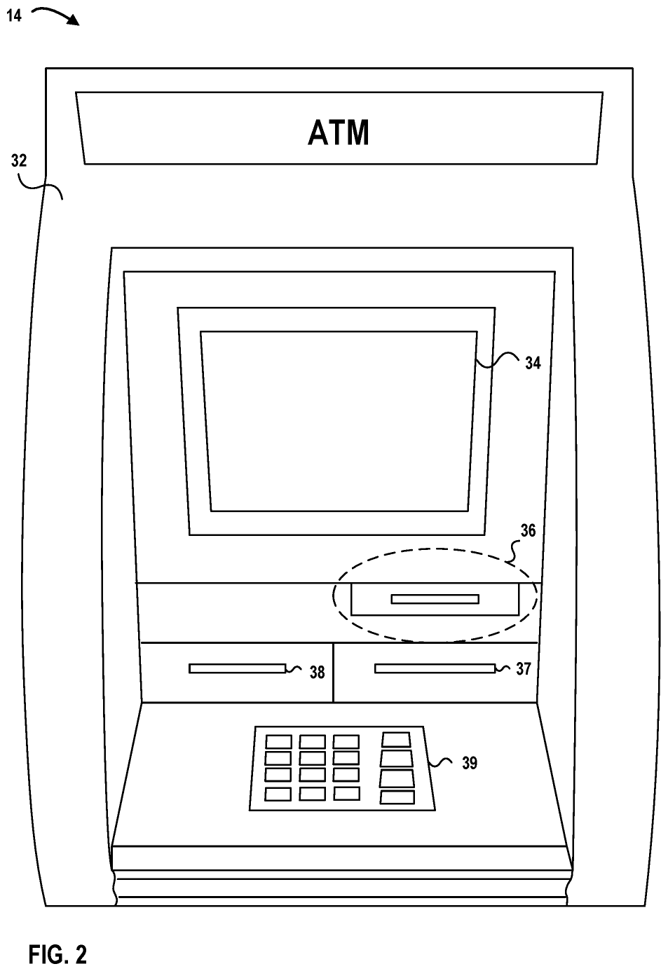

FIG. 2 is a conceptual diagram further illustrating an example digital ink ATM 14, in accordance with aspects of the disclosure. Digital ink ATM 14 includes a display 34, a card reader component 36, a digital ink display component 32, and a keypad 39. Digital ink ATM 14 may operate substantially similar to any of digital ink ATMs 14 from FIG. 1. For example, digital ink ATM 14 may be in communication with one or more ATM servers 28 and one or more bank servers 16 in one or more bank systems 22 of bank networks 20 over network 18 from FIG. 1. The architecture of digital ink ATM 14 illustrated in FIG. 2 is shown for exemplary purposes only, and digital ink ATM 14 should not be limited to this architecture. In some examples, digital ink ATM 14 may include additional components that, for clarity, are not shown in FIG. 2. In other examples, digital ink ATM 14 may be configured in a variety of ways.

Digital ink ATM 14 may contain a cash dispenser 37 and a printer component 38. Cash dispenser 37 may dispense cash to a user of digital ink ATM 14, such as during a withdrawal transaction. Printer component 38 may print receipts for various transactions and/or account balance checks performed using digital ink ATM 14. In some examples, cash dispenser 37 and/or printer component 38 may include different components such as, for example, components for accepting cash, a component for vending/accepting checks, a component to dispense envelopes, or the like. Digital ink ATM 14 may contain two components such as cash dispenser 37 and printer component 38, or digital ink ATM 14 may contain fewer or greater components for performing financial transactions, in accordance with aspects of the disclosure.

Digital ink ATM 14 may include card reader component 36. Card reader component 36 may include a card slot that allows the user to insert his or her debit, credit, or ATM card (referred to herein as “payment card”) to perform financial transactions using digital ink ATM 14. For example, once a user decides to initiate a transaction at digital ink ATM 14, the user may insert a payment card that contains identifying information included in a cryptogram of the payment card. The identifying information may include the user's name, account number, or the like. The identifying information may be contained in a magnetic stripe of the card and/or an integrated circuit (IC) chip of the payment card that is read by card reader component 36. In other examples, card reader component 36 may comprise a contactless card reader configured to emit a short-range signal requesting information from any payment cards brought near the contactless card reader.

In some examples, digital ink ATM 14 may prompt the user to input a PIN, OTP, access code, password, or biometric marker or signal in order to further verify their identity for the transaction. For example, a display may prompt the user to enter the PIN, and the user may enter the PIN using display 34 or keypad 39. In other examples, a fingerprint or retinal scan may be entered using a biometric input device. Upon receipt of the user's identifying information and/or user credentials, digital ink ATM 14 may send the identifying information and/or user credentials to a server device, e.g., one of ATMs servers 28 or bank servers 16 of FIG. 1. Upon authentication of the user by the server device, digital ink ATM 14 may allow the user to perform a transaction.

Digital ink ATM 14 may include a display 34 for inputting information, performing transactions, showing informational videos, or the like. A GUI presented on display 34 may allow a user to interact with digital ink ATM 14 by display of graphical icons and visual indicators. For example, display 34 may present a GUI that displays recommended actions and/or other options to a user. In certain examples, display 34 may be a touch sensitive screen and may present one or more touch sensitive GUI elements. For example, a user may be able to interact with digital ink ATM 14 to respond to options displayed on display 34 and initiate an action by touching one or more of the touch sensitive GUI elements displayed on display 34. For example, display 34 may be a presence-sensitive display that displays a GUI and receives input from a user using capacitive, inductive, and/or optical detection at or near the presence sensitive display. Additionally, or alternatively, a user may be able to interact with digital ink ATM 14 to respond to options displayed on display 34 and initiate an action by using any suitable input device such as, for example, keypad 39, a touchpad, a biometric input device, and/or any other suitable input device. Display 34 may include a cathode ray tube (CRT) monitor, a liquid crystal display (LCD), organic light emitting diode (OLED), or any other type of display device that can generate intelligible output to a user. Display 34 may also be a digital ink display.

In some examples, display 34 may present a user interface in which a user may perform an action in order to unlock the screen and begin using digital ink ATM 14. For example, as shown in FIG. 2, display 34 may show an introduction user interface that directs the user to touch display 34 anywhere or to swipe his or her finger or hand across display 34 in the direction of an arrow, or that directs the user to push any button on keypad 39 to unlock the screen. Display 34 may prompt the user to input a response before presenting a display used to initiate a transaction. Upon receiving the response, display 34 may present a screen allowing the user to perform various transactions using digital ink ATM 14.

According to the disclosed techniques, digital ink ATM 14 includes digital ink display component 32. Digital ink display component 32 displays branding information, such as color schemes, logos, graphical icons, visual indicators, and other images that are specific to a financial institution. For example, once a user has dipped their card into card reader component 36, digital ink ATM 14 may send to a server device, e.g., ATM server 28 of FIG. 1, and in response, receive instructions from the server device to display the branding information specific to the financial institution via digital ink display 32. In some examples, display 34 may also display some portion of the branding information.

Digital ink display component 32 may consist of one or more panels or other hardware devices that can support digital ink or electrophoretic technology. Digital ink display types may include, but are not limited to, bi-stable LCDs, MEMS, or E-ink Corporation displays. Digital ink display 32 may include an all-in-one display or an externally controlled display. Digital ink display 32 may be controlled by one or more controllers. In one embodiment, digital ink display 32 may display branding information in black and white. In another embodiment, digital ink display 32 may display branding information in greyscale. In another embodiment, digital ink display 32 may display branding information in multiple colors.

Digital ink display 32 may include a panel comprising components typically found within digital ink displays. For example, digital ink display 32 may include a panel comprising a bottom electrode or back plate consisting of a thin film transistor, a liquid polymer layer containing multiple capsules, a color filter, and a transparent top electrode. Each capsule within the liquid polymer layer contains charged particles or ink. A charge or electric field applied by a display driver across the multi-layered panel results in certain charged particles or ink moving towards or away from the transparent top electrode in a way that results in a certain image being displayed on digital ink display 32. The display driver may be provided with the branding information by the server device via a network or other communication channel or protocol.

Once the display driver for digital ink display 32 has applied the necessary charges across digital ink display 32 to display the branding information, digital ink display 32 may display the branding information for an indefinite amount of time. For example, digital ink display 32 may display the branding information for a first financial institution for a session duration of one or more transactions requested by a first user at digital ink ATM 14 or until a second user initiates a session at the ATM to perform transactions with a bank account associated with a second financial institution. For example, upon a first user of a first bank requesting a transaction at digital ink ATM 14, digital ink ATM 14 may receive branding information specific to the first bank and display the branding information via digital ink display 32. Digital ink display 32 may, in one example, display the logo of the first bank at the top of digital ink ATM 14 and display a solid color associated with a color scheme of the first bank X around the exterior body of digital ink ATM 14. Digital ink display 32 may maintain this display until a second user of a second bank requests a transaction at digital ink ATM 14. In another example, digital ink display 32 may be cleared by digital ink ATM 14 upon the first user completing their transactions, wherein digital ink display 32 may no longer display any branding information from any particular financial institution upon completion of a user session.

In one example, to request a cash withdrawal, a user may interact with digital ink ATM 14 to respond to options displayed on display 34. Display 34 may first prompt the user to select a transaction type such as a cash withdrawal. To initiate the cash withdrawal, the user may then dip their payment card into card reader component 36. Digital ink ATM 14 may also prompt the user to input a PIN using display 34 or keypad 39. Digital ink ATM 14 may then send the cryptogram and user credentials to a server device, wherein the server device may process the cryptogram to determine the financial institution associated with the payment card. The server device transmits instructions for display of branding information specific to the identified financial institution to display drivers of digital ink ATM 14 via one or more communication modules. The drivers of display 34 and digital ink display 32 may then apply the necessary charges across each display to generate the one or more images of the branding information in accordance with the instructions and display them to the user.

After authentication of the user of the payment card to access the bank account via the ATM based on validating the user credentials, the user may request a transaction, such as a cash withdrawal, at digital ink ATM 14. Digital ink ATM 14 may send the transaction request to the server device and, in response to receipt of authorization from the server device, complete the cash withdrawal. Digital ink ATM 14 may deliver the requested cash to the user via cash dispenser 37. Upon the user receiving the cash via cash dispenser 37, digital ink display 32 and display 34 may no longer display the branding information specific to the associated financial institution.

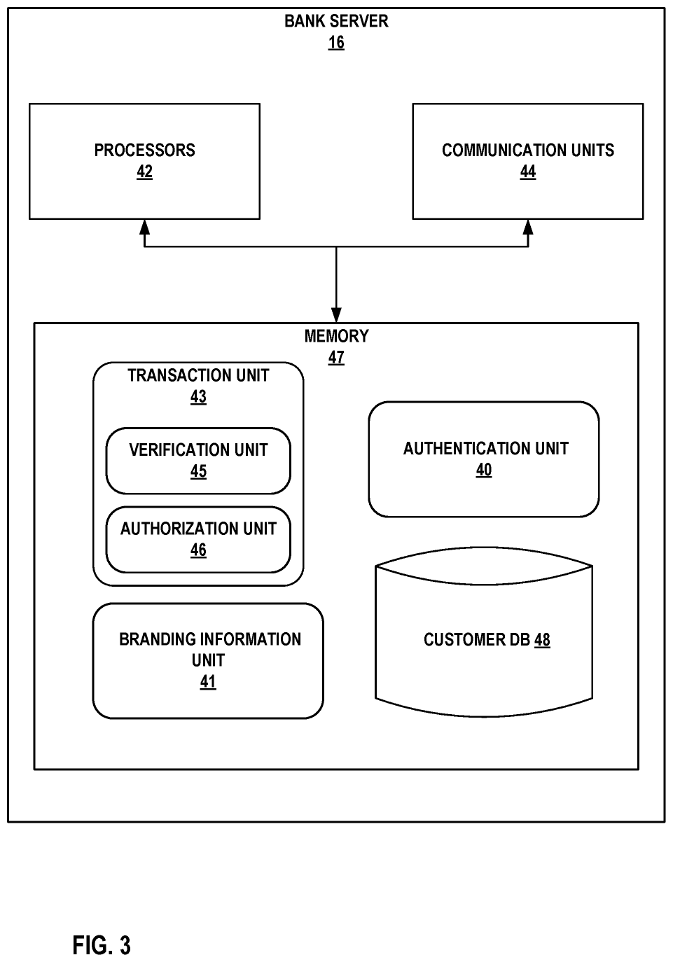

FIG. 3 is a block diagram illustrating an example bank server 16 configured to facilitate ATM transactions and send branding information to an ATM server or directly to a digital ink ATM, in accordance with the techniques of this disclosure. Bank server 16 may operate substantially similar to any of bank servers 16 from FIG. 1. The architecture of bank server 16 illustrated in FIG. 3 is shown for exemplary purposes only. Bank server 16 should not be limited to the illustrated example architecture. In other examples, bank server 16 may be configured in a variety of ways.

As shown in the example of FIG. 3, bank server 16 includes one or more processors 42, one or more communication units 44, and one or more memory units 47. Bank server 16 includes transaction unit 43 including a verification unit 45 and an authorization unit 46, authentication unit 40, and branding information unit 41, each of which may be implemented as program instructions and/or data stored in memory 47 and executable by processors 42 or implemented as one or more hardware units or devices of bank server 16. In the example of FIG. 3, memory 47 also stores a customer database 48, but in other examples such a database may be stored in a data center or storage network of bank network 20 of FIG. 1. Memory 47 of bank server 16 may also store an operating system (not shown) executable by processors 42 to control the operation of components of bank server 16. Although not shown in FIG. 3, the components, units, or modules of bank server 16 are coupled (physically, communicatively, and/or operatively) using communication channels for inter-component communications. In some examples, the communication channels may include a system bus, a network connection, an inter-process communication data structure, or any other method for communicating data.

Processors 42, in one example, may comprise one or more processors that are configured to implement functionality and/or process instructions for execution within bank server 16. For example, processors 42 may be capable of processing instructions stored by memory 47. Processors 42 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Memory 47 may be configured to store information within bank server 16 during operation. Memory 47 may include a computer-readable storage medium or computer-readable storage device. In some examples, memory 47 include one or more of a short-term memory or a long-term memory. Memory 47 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 47 is used to store program instructions for execution by processors 42. Memory 47 may be used by software or applications running on bank server 16 to temporarily store information during program execution.

Bank server 16 may utilize communication units 44 to communicate with external devices via one or more networks, e.g., network 18 and/or bank network 20 of FIG. 1. Communication units 44 may be network interfaces, such as Ethernet interfaces, optical transceivers, radio frequency (RF) transceivers, or any other type of devices that can send and receive information. Other examples of such network interfaces may include Wi-Fi, NFC, or Bluetooth® radios. In some examples, bank server 16 utilizes communication unit 44 to wirelessly communicate with external devices, e.g., other bank servers 16, ATM servers 28, and/or digital ink ATMs 14 of FIG. 1, or other computing devices within its own bank network.

In accordance with the techniques described in this disclosure, bank server 16 facilitates ATM transactions at one or more digital ink ATMs 14 of FIG. 1. Bank server 16 comprises at least one server configured to support a bank system of a financial institution, such as one of bank systems 22 of FIG. 1.

Authentication unit 40 of bank server 16 performs user authentication to provide users with secure access to their bank accounts. More specifically, authentication unit 40 receives, from an ATM or an ATM server, a cryptogram of a user's payment card read at the ATM. The cryptogram may include a unique identifier of the associated financial institution and user information that may include card data (e.g., card number, user name, or other user or account identification data stored on the payment card) and terminal data (e.g., location or identification number of the ATM). In addition, authentication unit 40 receives user credentials from the ATM or the ATM server including a PIN, OTP, access, or biometric marker or signal.

Authentication unit 40 compares the received user information and user credentials against stored information for the user. The stored information may be securely held in customer database 48. More specifically, authentication unit 40 may perform a lookup in customer database 48 to determine whether an entry exists in database 48 that matches the bank account or particular payment card information included in the cryptogram of the payment card at the ATM. In some examples customer database 48 may be a data center or storage network of a bank network that is accessible by bank server 16 via communication units 44. Upon validating the user information and credentials, authentication unit 40 authenticates the user to access the bank account via the ATM.

Branding information unit 41 of bank server 16 provides branding information specific to the financial institution associated with the payment to the ATM. Branding information unit 41 may generate a file that includes the branding information relating to the user's financial institution. The branding information may, for example, include color schemes, logos, icons and/or other images that are specific to the user's financial institution. Bank server 16 may then send the file to the ATM server or directly to the ATM.

Upon authentication, the user may initiate an ATM transaction with the bank account via a digital ink ATM. The digital ink ATM receives transaction data from the user via a user interface of the digital ink ATM. The digital ink ATM then sends the transaction data to an ATM server, e.g., ATM server 28 of FIG. 1, or to bank server 16. Transaction unit 43 of bank server 16 receives transaction data from either the ATM or the ATM server and performs authorization processes to authorize or deny the requested transactions. In some examples, transaction unit 43 may utilize communication units 44 of bank server 16 to send and receive transactions to and from ATMs and/or ATM servers. In some examples, transaction unit 43 may receive input specifying a type of transaction and an amount of funds for the type of transaction. Verification unit 45 may verify that the type of transaction can be performed using the bank account and that the bank account has an account balance that is sufficient to perform the type of transaction for the amount of funds. This verification step ensures accuracy of the requested transaction and preemptively identifies any potential issues that may result in failure to complete the transaction.

Authorization unit 46 of transaction unit 43 may determine, based on identifying information included in the cryptogram of the payment card and information stored in customer database 48, that the user's transaction can be completed at the digital ink ATM. Upon determining that the user's transaction can be completed at the digital ink ATM, transaction authorization unit 46 may use communication units 44 to communicate the authorization to the digital ink ATM directly or via the ATM server. Transaction authorization unit 46 may also use communication units 44 to communicate with the digital ink ATM directly or the ATM server to initiate the transfer of funds with the bank account of the user for the transaction and send any necessary instructions to the digital ink ATM to dispense or receive the funds.

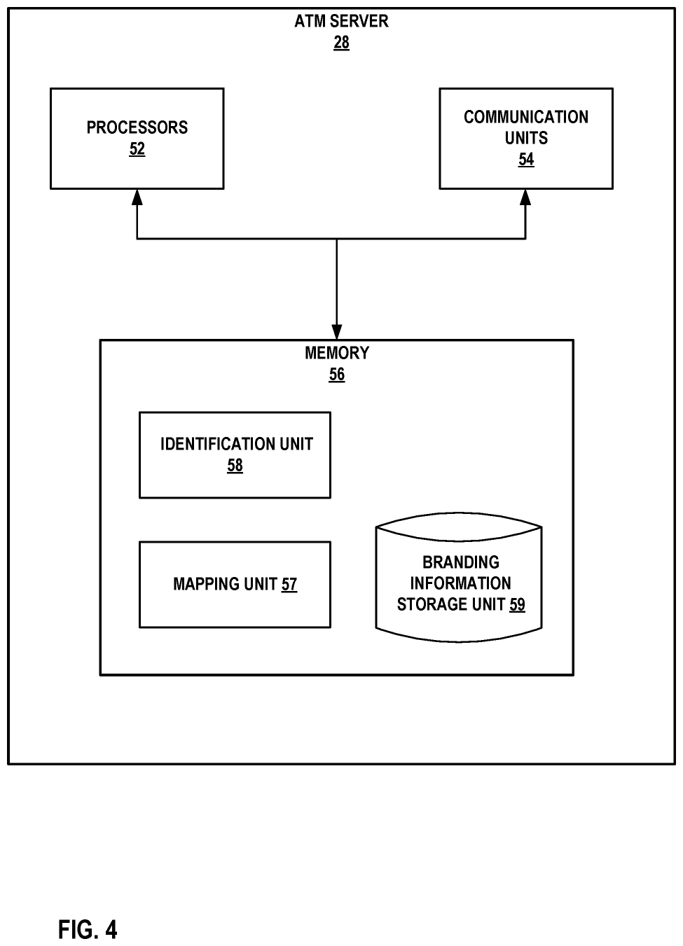

FIG. 4 is a block diagram illustrating an example ATM server 28 configured to send branding information to a digital ink ATM, in accordance with the techniques of this disclosure. ATM server 28 may operate substantially similar to any of ATM servers 28 from FIG. 1. The architecture of ATM server 28 illustrated in FIG. 4 is shown for exemplary purposes only. ATM server 28 should not be limited to the illustrated example architecture. In other examples, ATM server 28 may be configured in a variety of ways.

As shown in the example of FIG. 4, ATM server 28 includes one or more processors 52, one or more communication units 54, and one or more memory units 56. ATM server 28 includes identification unit 58 and mapping unit 57 within memory unit 56, which may be implemented as program instructions and/or data stored in memory 56 and executable by processors 52 or implemented as one or more hardware units or devices of ATM server 28. In the example of FIG. 4, memory 56 also stores branding information storage unit 59, but in other examples such a database may be stored in a data center or storage network of bank network 20 of FIG. 1. Memory 56 of ATM server 28 may store an operating system (not shown) executable by processors 52 to control the operation of components of ATM server 28. Although not shown in FIG. 4, the components, units, or modules of ATM server 28 are coupled (physically, communicatively, and/or operatively) using communication channels for inter-component communications. In some examples, the communication channels may include a system bus, a network connection, an inter-process communication data structure, or any other method for communicating data.

Processors 52, in one example, may comprise one or more processors that are configured to implement functionality and/or process instructions for execution within ATM server 28. For example, processors 52 may be capable of processing instructions stored by memory 56. Processors 52 may include, for example, microprocessors, DSPs, ASICs, FPGAs, or equivalent discrete or integrated logic circuitry, or a combination of any of the foregoing devices or circuitry.

Memory 56 may be configured to store information within ATM server 28 during operation. Memory 56 may include a computer-readable storage medium or computer-readable storage device. In some examples, memory 56 include one or more of a short-term memory or a long-term memory. Memory 56 may include, for example, RAM, DRAM, SRAM, magnetic discs, optical discs, flash memories, or forms of EPROM or EEPROM. In some examples, memory 56 is used to store program instructions for execution by processors 52. Memory 56 may be used by software or applications running on ATM server 28 to temporarily store information during program execution.

ATM server 28 may utilize communication units 54 to communicate with external devices via one or more networks, e.g., network 18 and/or bank network 20 of FIG. 1.

Communication units 54 may be network interfaces, such as Ethernet interfaces, optical transceivers, RF transceivers, or any other type of devices that can send and receive information. Other examples of such network interfaces may include Wi-Fi, NFC, or Bluetooth® radios. In some examples, ATM server 28 utilizes communication unit 54 to wirelessly communicate with external devices, e.g., bank servers 16, digital ink ATMs 14, or other ATM servers 28 within ATM system 26 of FIG. 1, or other computing devices. ATM server 28 may utilize communication units 54 to receive financial institution-specific branding information from a bank server associated with the financial institution. For example, ATM server 28 may receive a file containing the branding information, which may include color schemes, logos, icons and/or other images that are specific to the user's financial institution, from the associated bank server via communication units 54. Upon receipt of the file, processors 52 may then process the file and communicate with display drivers of an ATM to transmit instructions for the ATM to display the branding information included in the file via a digital ink display component of the ATM.

In accordance with the techniques described in this disclosure, ATM server 28 provides branding information to a digital ink ATM, such as one of digital ink ATMs 14 of FIG. 1. Identification unit 58 of memory 56 may determine the financial institution associated with the user based on a unique identifier included in a cryptogram of a payment card ready by the ATM. Upon receiving the cryptogram from the ATM, identification unit 58 may determine the financial institution associated with the payment card based on the unique identifier of the financial institution that is included within the cryptogram. For example, identification unit 58 may determine the financial institution associated with the payment card by comparing identifying numbers on the payment card with stored information that relates the identifying numbers to a specific financial institution. In some cases, the first four digits of an account number of a payment card may indicate an associated financial institution, e.g., a bank, credit union, or other card-issuing entity.

Upon identifying the user's financial institution, ATM server 28 retrieves the branding information specific to the financial institution based on the unique identifier and transmits instructions to the ATM to display the branding information specific to the financial institution via a digital ink component of the ATM. In some examples, ATM server 28 retrieves the branding information specific to a user's financial institution from a cache or other local storage unit based on the unique identifier of the financial institution. Branding information storage unit 59, for example, may be a cache that stores branding information temporarily and is accessible to ATM server 28. In some examples, branding information storage unit 59 may only store branding information for the duration of the user's transaction at digital ink ATM 14. In other examples, branding information storage unit may store branding information for multiple financial institutions, wherein branding information for each financial institution is indexed by the unique identifier of the financial institution that is determined by identification unit 58. Mapping unit 57 may map the unique identifier of the financial institution that is determined by identification unit 58 to the branding information stored in branding information storage unit 59. ATM server 28 may then access branding information storage unit 59 and transmit instructions to display the branding information to the digital ink ATM, wherein the digital ink ATM displays the branding information to the user via a digital ink display component of the ATM.

In some examples, mapping unit 59 may determine that an entry does not exist in branding information storage unit 59 that corresponds to the unique identifier of the financial institution. In other examples, ATM server 28 may not locally store branding information for financial institutions. In either of the above examples, ATM server 28 may retrieve the branding information specific to the financial institution from a bank server associated with the identified financial institution. ATM server 28 may determine the bank server associated with the financial institution based on the unique identifier of the financial institution. ATM server 28 may send a request for the branding information to the bank server and receive the branding information from the bank server. In some scenarios, ATM server 28 may also send the cryptogram of the payment card and user credentials to the bank server associated with the identified financial institution for user authentication. ATM server 28 may request the branding information from the bank server in response to receipt of each cryptogram identifying the associated financial institution. In other examples, ATM server 28 may request the branding information from the bank server only in response to receipt of a first cryptogram identifying a particular financial institution and, upon receipt of the branding information from the bank server, processors 52 of ATM server 28 store the branding information in an entry of branding information storage unit 59 indexed by the unique identifier of the financial institution. ATM server 28 may then transmit instructions to display the branding information to the digital ink ATM, wherein the digital ink ATM displays the branding information to the user via a digital ink display component of the ATM.

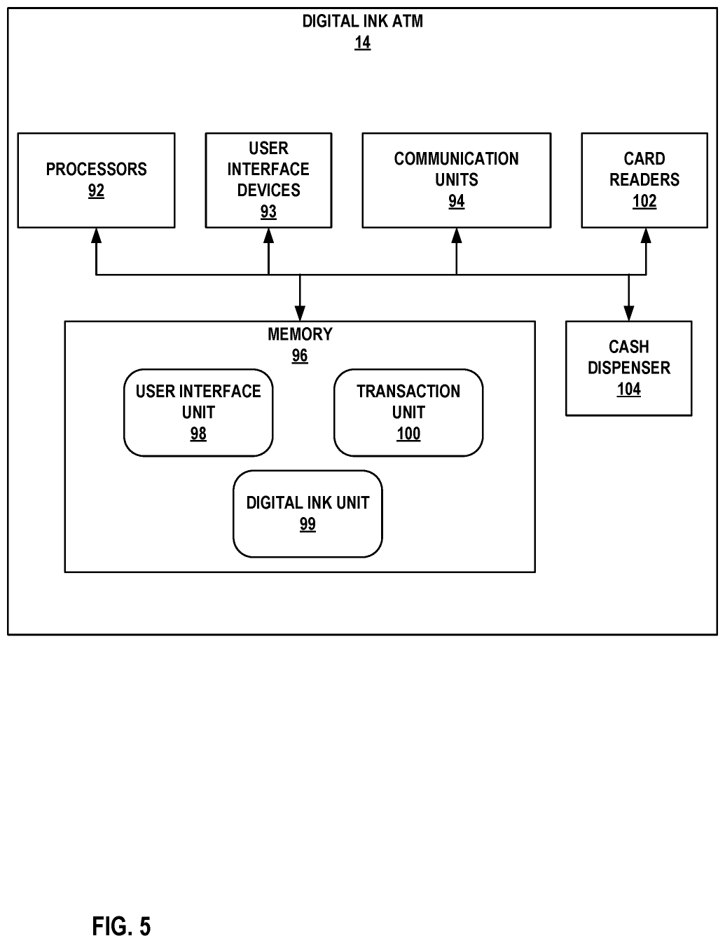

FIG. 5 is a block diagram illustrating an example digital ink ATM 14, in accordance with aspects of the disclosure. Digital ink ATM 14 may operate substantially similar to any of digital ink ATMs 14 from FIG. 1. The architecture of digital ink ATM 14 illustrated in FIG. 5 is shown for exemplary purposes only, and digital ink ATM 14 should not be limited to this architecture. In some examples, digital ink ATM 14 may include additional components that, for clarity, are not shown in FIG. 5. In other examples, digital ink ATM 14 may be configured in a variety of ways.

As shown in the example of FIG. 5, digital ink ATM 14 includes one or more processors 92, one or more display units 93, one or more communication units 94, one or more memory units 96, one or more card readers 102, and a cash dispenser 104. Digital ink ATM 14 also includes user interface unit 98, digital ink unit 99, and transaction unit 100, each of which may be implemented as program instructions and/or data stored in memory 96 and executable by processors 92 or implemented as one or more hardware units or devices of digital ink ATM 14. In some examples, memory 96 of digital ink ATM 14 may also store an operating system executable by processors 92. The operating system stored in memory 96 may control the operation of components of digital ink ATM 14. The components, units or modules of digital ink ATM 14 are coupled (physically, communicatively, and/or operatively) using communication channels for inter-component communications. In some examples, the communication channels may include a system bus, an inter-process communication data structure, or any other method for communicating data. Digital ink ATM 14 may include additional components that, for clarity, are not shown in FIG. 5. Similarly, the components of digital ink ATM 14 shown in FIG. 5 may not be necessary in every example of digital ink ATM 14.

Processors 92, in one example, may include one or more processors that are configured to implement functionality and/or process instructions for execution within digital ink ATM 14. For example, processors 92 may be capable of processing instructions stored by memory 96. Processors 92 may include, for example, microprocessors, DSPs, ASICs, FPGAs, or equivalent discrete or integrated logic circuitry, or a combination of any of the foregoing devices or circuitry.

Memory 96 may be configured to store information within digital ink ATM 14 during operation. Memory 96 may include a computer-readable storage medium. In some examples, memory 96 includes one or more of a short-term memory or a long-term memory. Memory 96 may include, for example, RAM, DRAM, SRAM, magnetic discs, optical discs, flash memories, or forms of EPROM or EEPROM. In some examples, memory 96 is used to store program instructions for execution by processors 92. Memory 96 may be used by software running on digital ink ATM 14 (e.g., user interface unit 98, digital ink unit 99, and/or transaction unit 100) to temporarily store information during program execution.

Digital ink ATM 14 may utilize communication units 94 to communicate with external devices via one or more networks, e.g., ATM servers 28 of ATM system 26 and/or bank servers 16 of bank system 22 via network 18 from FIG. 1, or via wireless signals. Communication units 94 may be network interfaces, such as Ethernet interfaces, optical transceivers, RF transceivers, or any other type of devices that can send and receive information. Other examples of interfaces may include Wi-Fi, NFC, or Bluetooth® radios. In some examples, digital ink ATM 14 utilizes communication units 94 to wirelessly communicate with proximate external devices, such as a physical card or a user device executing a mobile wallet application including a virtual card.

Digital ink ATM 14 may include display devices 93 to communicate with users of digital ink ATM 14. User interface devices 93 may be configured to operate as both input devices and output devices. For example, user interface devices 93 may be configured to receive tactile, audio, or visual input from a user of digital ink ATM 14. In addition to receiving input from a user, user interface devices 93 may be configured to provide output to a user using tactile, audio, or video stimuli. In one example, user interface devices 93 may be configured to output content for display, e.g., a GUI, in accordance with user interface unit 98 stored in memory 96. In some such examples, user interface devices 93 may include a presence-sensitive display that displays a GUI and receives input from a user using capacitive, inductive, and/or optical detection at or near the presence sensitive display. Other examples of user interface devices 93 include a keypad, touchpad, a voice responsive system, video camera, microphone, or any other type of device for detecting a command from a user, or a sound card, a video graphics adapter card, or any other type of device for converting a signal into an appropriate form understandable to humans or machines. Additional examples of user interface devices 93 include a speaker, a CRT monitor, an LCD, OLED, or any other type of device that can generate intelligible output to a user. User interface devices 93 include, for example, display 24 and digital ink display 32 of FIG. 2. Processors 92 may execute user interface 98 to drive display devices such as display 24 and digital ink display 32 based on input received from user interface devices 93 or files received from external devices via one or more communication modules, e.g., ATM servers 28 of ATM system 26 and/or bank servers 16 of bank system 22 via network 18 from FIG. 1.

Digital ink ATM 14 includes one or more card readers 102 configured to read or otherwise receive cryptograms from payment cards, e.g., physical payment card or virtual payment cards within a mobile wallet application running on a user device. For example, card readers 102 may include a dip card reader configured to receive a cryptogram upon the user inserting or dipping a portion of the physical payment card that includes an IC chip into a slot of the dip card reader. In addition, card readers 102 may include a contactless card reader configured to emit a short-range signal requesting information from any payment cards brought near the contactless card reader such that the contactless card reader may receive the cryptogram from the IC chip of a physical card in response to the user waving or tapping the physical card near the contactless card reader. The contactless card reader may similarly receive the cryptogram from the virtual card in response to the user waving or tapping the user device executing the mobile wallet application near the contactless card reader. Digital ink ATM 14 further includes a cash dispenser 104 configured to dispense a requested amount of funds in the form of banknotes via an opening in an exterior housing of digital ink ATM 14. In some examples, cash dispenser 104 may dispense the banknotes within an envelope.

In accordance with the techniques described in this disclosure, digital ink ATM 14 is configured to receive the cryptogram of the payment card via one of card readers 102 and, prior to prompting a user of the payment card for transaction data via a user interface, digital ink ATM 14 may send the cryptogram to an ATM server to identify the user's financial institution and further authenticate the user. Traditionally, a user may choose to initiate a transaction at an ATM that is owned a financial institution where the user is a customer or has an account. The user may choose to initiate their transaction at that specific ATM based on visual indicators, e.g., colors, logos, images, or other branding information, that is indicative of the user's financial institution. Digital ink ATM 14, however, may be a generic ATM, wherein no single financial institution's branding is constantly displayed across the ATM exterior. The techniques described herein enable the user to initiate a transaction at digital ink ATM 14 regardless of which financial institution the user has an account with.

As described above, card readers 102 are configured to receive cryptograms from a user's payment card, wherein the payment card may be associated with any financial institution. Upon receiving the cryptogram, card readers 102 send the cryptogram to an ATM server, similar to ATM servers 28 of FIG. 1 and FIG. 4, which then processes and identifies the user's financial institution based on a unique identifier of the financial institution included in the cryptogram. The ATM server may then communicate with a bank server owned by the user's financial institution to authenticate the user and receive branding information that can be displayed to the user prior to the user requesting a transaction.

Upon receipt of the branding information file via communication units 94, processors 92 may process the branding information and communicate with display drivers of user interface devices 93 to display the contents to the user via a display device of user interface devices 93. User interface devices 93 may include one or more digital ink displays, such as digital ink display 32 of FIG. 2, and one or more cathode ray tube (CRT) monitors, liquid crystal displays (LCDs), organic light emitting diodes (OLEDs), or any other type of display device, such as display 34 of FIG. 2. In some examples, user interface unit 98 may receive the contents of the branding information file and then generate a user interface that is indicative of the user's financial institution on one or more of user interface devices 93. In some examples, digital ink unit 99 may receive the contents of the branding information file and then generate instructions for a digital ink display, such as digital ink display 32 of FIG. 2, to display the branding information that is indicative of the user's financial institution. More specifically, digital ink unit 99 may send, to display drivers of digital ink ATM 14 via one or more communication modules 94, instructions to display the branding information via digital ink display 32. The drivers of digital ink display 32 may then apply the necessary charges across each display to generate the one or more images and display them to the user via digital ink display 32.

For example, a user may first approach digital ink ATM 14, wherein digital ink ATM 14 displays no branding information indicative of any particular financial institution. In other examples, digital ink ATM 14 may display the branding information of a particular financial institution that a previous user at the ATM has an account with. The current user may insert their payment card into one or more card readers 102, and upon receipt of a cryptogram from the payment card via one or more card readers 102, user interface unit 98 of digital ink ATM 14 may generate a user interface on a display device of user interface devices 93. In some examples, the user interface that is generated or displayed may not be indicative of the user's financial institution. In other examples, digital ink ATM 14 may first wait to receive branding information specific to the financial institution associated with the payment card, and upon receipt of the branding information, generate a user interface on a display device of user interface devices 93 that is indicative of the financial institution. In some examples, the user interface may present a notification to the user that the payment card has been read. In other examples, the user may perform steps such as enter other user credentials, e.g., a PIN, OTP, access code, or biometric markers or signals, in response to prompts via the user interface. In still other examples, the user interface may provide a notification to the user to wait before attempting to enter user credentials via one of user interface devices 93.

Continuing the above example, upon receipt of the cryptogram from the payment card via one or more card readers 102, digital ink ATM 14 sends the cryptogram to a server of digital ink ATM 14, e.g., ATM server 28 of FIG. 4, via communication units 94. ATM server 28 then processes the cryptogram and identifies the financial institution associated with the user's payment card via identification unit 58. ATM server 28 then communicates with a bank server, e.g., bank server 16 of FIG. 3. Bank server 16 may then process the identifying information received from ATM server 28 and authenticate the user.

In some examples, authentication of the user may involve the user identifying a user-specific image that is provided by the user's identified financial institution to digital ink ATM 14. For example, prior to the user entering in any additional identifying information or credentials such as a PIN, OTP, or access code, the user may only dip their payment card into card reader 102. ATM server 28 may then receive the cryptogram from the payment card via communication units 94, determine the financial institution associated with the payment card, and send a request to bank server 16 associated with the financial institution for the user-specific image. Bank server 16 may then send the user-specific image to ATM server 28, and ATM server 28 may further transmit display instructions to display drivers of digital ink ATM 14 to display the user-specific image. Upon displaying the user-specific image via one or more user interface devices 93, digital ink ATM 14 may request the user to verify the user-specific image. In addition to sending user credentials such as a PIN, OTP, or access code to ATM server 28, digital ink ATM 14 may also send an indication of the user-specific image to ATM server 28. In this example, ATM server 28 may then send user identifying information and/or user credentials as well as the indication of the user-specific image to bank server 16, wherein bank server 16 authenticates the user based on validating the user credentials of the user and the indication of the user-specific image.

Bank server 16 may then authorize the transaction and send the authorization to transaction unit 100 via communication units 94. Upon receiving authorization, digital ink ATM 14 may perform the transaction. In some examples, if the transaction is an account balance check, check cashing, or a fund transfer, user interface unit 98 may generate a user interface to present a notification to the user that the transaction has been completed. In other examples, if the transaction is a withdrawal or a fund deposit, transaction unit 100 may use cash dispenser 104 to dispense the amount of funds for the transaction to the user or may use cash dispenser 104 or another receptacle of digital ink ATM 14 to receive the amount of funds (e.g., in the form of cash or check) for the transaction.

User interface devices 93 may also be used to indicate the status of digital ink ATM 14. For example, certain color schemes displayed by user interface devices 93 may signify “out of cash” or “out of order.” Authorized users or technicians may be able to obtain specific information based on the color scheme.

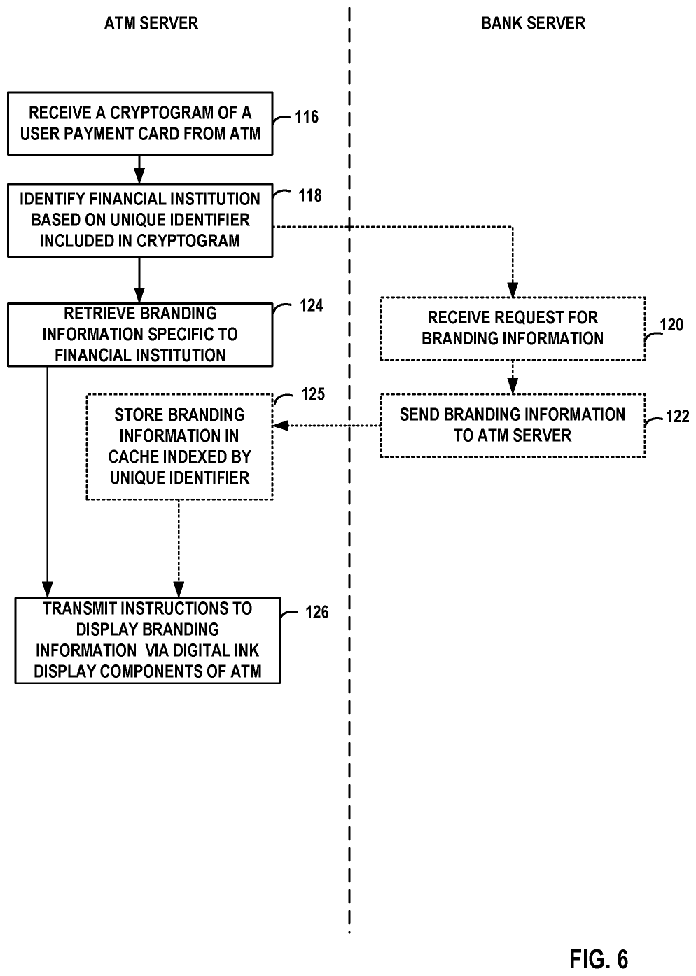

FIG. 6 is a flow chart illustrating an example operation of server devices to facilitate an ATM transaction for a user and provide financial institution-specific branding and transactions to a digital ink ATM, in accordance with aspects of the disclosure. The example technique of FIG. 6 will be described with respect to bank server 16 and ATM server 28 of FIG. 3 and FIG. 4, respectively.

ATM server 28 receives, from a digital ink ATM, a cryptogram of a payment card that a user presents at the digital ink ATM (116). The digital ink ATM may receive the cryptogram of the payment card when the payment card is proximate to the digital ink ATM. In one example, the payment card used to initiate the transaction at the digital ink ATM may be a physical card including an IC chip that stores the identifying information. In one scenario, a card reader of the digital ink ATM may receive the cryptogram from the IC chip of the physical card in response to the user inserting or dipping the physical card into a slot of the card reader. In another scenario, a card reader of the digital ink ATM may emit a short-range signal requesting information from any payment cards brought near the card reader such that the card reader may receive the cryptogram from the IC chip of the physical card in response to the user waving or tapping the physical card near the card reader.

ATM server 28 determines, based on a unique identifier included in the cryptogram of the payment card, the financial institution associated with the payment card (118). More specifically, upon receiving the cryptogram, identification unit 58 of ATM server 28 may identify the financial institution associated with the payment card based on identifying information provided by the cryptogram. Identification unit 58 may determine the financial institution associated with the payment card by comparing identifying numbers on the payment card with stored information that relates the identifying numbers to specific financial institutions.

Upon determining the financial institution associated with the payment card presented at the digital ink ATM, ATM server 28 retrieves the branding information specific to the financial institution (124). In some examples, ATM server 28 may retrieve the branding information from a cache or other local storage, e.g., branding information storage unit 59, in which the branding information for the identified financial institution is stored and indexed by the unique identifier of the financial institution.

In other examples (as shown in the dotted line steps of the flowchart illustrated in FIG. 6), ATM server 28 may communicates with a bank server 16 associated with the identified financial institution in order to retrieve the branding information. Bank server 16 may first receive a request from ATM server 28 for the branding information specific to the financial institution (120). Branding information unit 41 of bank server 16 may then generate a file containing the branding information, which may include color schemes, logos, icons and/or other images that are specific to the user's financial institution. Bank server 16 then sends the file to ATM server 28 via a network (122). ATM server 28 may then process the file and store the branding information in the cache or local storage, e.g., branding information storage unit 59 (125). The branding information stored in branding information storage unit 59 may be indexed by the unique identifier included in the cryptogram of the payment card.

After retrieving the branding information specific to the identified financial institution, ATM server 28 then transmits instructions to the digital ink ATM to display the branding information via digital ink display components of the digital ink ATM (126). In response to the instructions, the digital ink ATM may display the branding information to the user via one or more digital ink display components. The display drivers of the digital ink ATM displays apply the necessary charges across each display to generate the one or more images. In some examples, the images may be continually updated throughout the user's transaction to display different images associated with the user's financial institution. In other examples, the images may remain static throughout the user's transaction. In some examples, prior to initiating the transaction, the digital ink ATM displays may not show any branding information indicative of any particular financial institution. In other examples, prior to initiating the transaction, the digital ink ATM displays the branding information of the financial institution associated with a previous user that completed a transaction at the digital ink ATM. In still other examples, prior to initiating the transaction, the digital ink ATM displays show multiple images indicative of multiple financial institutions with which the digital ink ATM can perform a transaction.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a mobile computing device, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A system including a server device, the server device comprising:
a memory; and
one or more processors in communication with the memory and configured to:
receive a cryptogram of a payment card of a user from an automated teller machine (ATM), wherein the ATM receives the cryptogram of the payment card when the payment card is read by the ATM;
identify, based on a unique identifier included in the cryptogram of the payment card, a financial institution associated with the payment card;
retrieve, based on the unique identifier, branding information specific to the financial institution; and
transmit, to the ATM, instructions to display the branding information specific to the financial institution via a digital ink display component of the ATM.

2. The system of claim 1, wherein the digital ink display component of the ATM comprises one or more panels, and wherein the instructions to display the branding information comprise instructions for each panel of the one or more panels of the digital ink display component of the ATM to display at least a portion of the branding information specific to the financial institution.

3. The system of claim 1, wherein the branding information specific to the financial institution includes one or more of a color scheme, logos, icons, or images specific to the financial institution.

4. The system of claim 1, wherein the instructions to display the branding information comprise instructions to display the branding information for a session duration of one or more transactions requested by the user of the payment card and performed at the ATM.

5. The system of claim 1, wherein to retrieve the branding information specific to the financial institution, the one or more processors of the server device are configured to retrieve the branding information from a cache of the server device based on the unique identifier of the financial institution.

6. The system of claim 1, wherein the one or more processors of the server device are configured to:
transmit, to the ATM, instructions to display a user-specific image via the digital ink display component of the ATM, the user-specific image selected based on user information included in the cryptogram of the payment card;
receive, from the ATM, user credentials for a bank account of the user and an indication of the user-specific image; and
authenticate the user of the payment card to access the bank account via the ATM based on validating the user credentials of the user and the indication of the user-specific image.

7. The system of claim 1, wherein the server device is a first server device associated with the ATM, and wherein the system further comprises one or more second server devices associated with respective financial institutions, wherein the one or more processors of the first server device are configured to determine a second server device associated with the identified financial institution based on the unique identifier of the financial institution.

8. The system of claim 7, wherein to retrieve the branding information specific to the financial institution, the one or more processors of the first server device are configured to:
send a request for the branding information to the second server device associated with the identified financial institution; and
receive the branding information from the second server device.

9. The system of claim 8, wherein the one or more processors of the first service device are configured to store the branding information specific to the identified financial institution in a cache of the first server device indexed by the unique identifier of the financial institution.

10. The system of claim 7, wherein the one or more processors of the first server device are configured to:
receive a user-specific image from the second server device based on user information included in the cryptogram of the payment card; and
transmit, to the ATM, instructions to display the user-specific image via the digital ink display component of the ATM.

11. The system of claim 10, wherein the second server device comprises a memory and one or more processors configured to:
receive, from one of the ATM or the first server device associated with the ATM, user credentials for a bank account of the user and an indication of the user-specific image; and
authenticate the user of the payment card to access the bank account via the ATM based on validating the user credentials of the user and the indication of the user-specific image.

12. The system of claim 1, wherein the payment card comprises a first payment card associated with a first financial institution, and wherein the one or more processors of the server device are configured to:
receive a second cryptogram of a second payment card from the ATM, wherein the ATM receives the second cryptogram of the second payment card when the second payment card is read by the ATM;
identify, based on a second unique identifier included in the second cryptogram of the second payment card, a second financial institution associated with the second payment card;
retrieve, based on the second unique identifier, second branding information specific to the second financial institution, wherein the second branding information specific to the second financial institution is different than the first branding information specific to the first financial institution; and
transmit, to the ATM, instructions to display the second branding information specific to the second financial institution via the digital ink display component of the ATM.

13. A method comprising:
receiving, by a server device of a computing system, a cryptogram of a payment card of a user from an automated teller machine (ATM), wherein the ATM receives the cryptogram of the payment card when the payment card is read by the ATM;
identifying, by the server device and based on a unique identifier included in the cryptogram of the payment card, a financial institution associated with the payment card;
retrieving, by the server device and based on the unique identifier, branding information specific to the financial institution; and
transmitting, by the server device and to the ATM, instructions to display the branding information specific to the financial institution via a digital ink display component of the ATM.

14. The method of claim 13, wherein retrieving the branding information specific to the financial institution comprises retrieving the branding information from a cache of the server device based on the unique identifier of the financial institution.

15. The method of claim 13, further comprising:
transmitting, to the ATM, instructions to display a user-specific image via the digital ink display component of the ATM, the user-specific image selected based on user information included in the cryptogram of the payment card;
receiving, from the ATM, user credentials for a bank account of the user and an indication of the user-specific image; and
authenticating the user of the payment card to access the bank account via the ATM based on validating the user credentials of the user and the indication of the user-specific image.

16. The method of claim 13, wherein the server device of the system is a first server device associated with the ATM, wherein the system further comprises one or more second server devices associated with respective financial institutions, and wherein the method further comprises determining, by the first server device, a second server device associated with the identified financial institution based on the unique identifier of the financial institution.

17. The method of claim 16, wherein retrieving the branding information specific to the financial institution comprises:
sending, by the first server device, a request for the branding information to the second server device associated with the identified financial institution;
receiving, by the first server device, the branding information from the second server device; and
storing, by the first server device, the branding information specific to the identified financial institution in a cache of the first server device indexed by the unique identifier of the financial institution.

18. The method of claim 16, further comprising:
receiving, by the first server device, a user-specific image from the second server device based on user information included in the cryptogram of the payment card; and
transmitting, by the first server device and to the ATM, instructions to display the user-specific image via the digital ink display component of the ATM.

19. The method of claim 13, wherein the payment card comprises a first payment card associated with a first financial institution, and wherein the method further comprises:
receiving a second cryptogram of a second payment card from the ATM, wherein the ATM receives the second cryptogram of the second payment card when the second payment card is read by the ATM;
identifying, based on a second unique identifier included in the second cryptogram of the second payment card, a second financial institution associated with the second payment card;
retrieving, based on the second unique identifier, second branding information specific to the second financial institution, wherein the second branding information specific to the second financial institution is different than the first branding information specific to the first financial institution; and
transmitting, to the ATM, instructions to display the second branding information specific to the second financial institution via the digital ink display component of the ATM.

20. A computer-readable medium storing instructions that, when executed, cause one or more processors to:
receive a cryptogram of a payment card of a user from an automated teller machine (ATM), wherein the ATM receives the cryptogram of the payment card when the payment card is read by the ATM;
identify, based on a unique identifier included in the cryptogram of the payment card, a financial institution associated with the payment card;
retrieve, based on the unique identifier, branding information specific to the financial institution; and
transmit, to the ATM, instructions to display the branding information specific to the financial institution via a digital ink display component of the ATM.
